(19) United States
(12) Patent Application Publication
(10) Pub. No.: US 2016/0247367 A1
(43) Pub. Date: Aug. 25, 2016

(54) SYSTEMS AND METHODS FOR COMMUNICATING VIA WEARABLE DEVICES

(71) Applicant: Jewelbots Inc., New York, NY (US)

(72) Inventors: Sara Jolene CHIPPS, Brooklyn, NY (US); Audrea Brooke MORELAND, New York, NY (US); Maria Paula SABA DOS REIS, Brooklyn, NY (US); George John STOCKER, III, Springfield, VA (US); Scott Michael DAVISON, Forest Hills, NY (US)

(21) Appl. No.: 15/048,626

(22) Filed: Feb. 19, 2016

Related U.S. Application Data
(60) Provisional application No. 62/118,415, filed on Feb. 19, 2015.

(51) Int. Cl. G08B 5/38

(52) U.S. Cl. CPC G08B 5/38

(57) ABSTRACT

Systems and methods are provided for users to communicate with encoded messages via their wearables devices. Users can send encoded messages by pressing on at least one button on the wearable devices. Pressing the at least one button in different sequences can mean different messages. The encoded messages can be sent from a first wearable device to a second wearable device, and the received encoded messages can be displayed as a configuration of at least one light on the second wearable device. Messages can be sent over any suitable communications medium from one wearable device to another wearable device. Devices can also use other wearable devices to relay messages. A wearable device can be paired with a communication device and use the communication device's network to send and/or receive messages over a long distance.

### RELATED APPLICATION

This application claims priority to U.S. Provisional Patent Application No. 62/118,415, titled “Systems And Methods For Communicating Via Wearables,” which was filed on Feb. 19, 2015 and is incorporated herein in its entirety.

### BACKGROUND OF THE INVENTION

1. Technical Field

The invention relates generally to the field of systems and methods for communicating among wearable devices.

2. Description of the Related Art

There are existing systems that allow for communication through wearable devices such as smart watches or fitness bands. There are, however, several limitations related to these existing wearable devices.

First, the users of the existing types of wearable devices generally need to rely on their smartphones or have a cellular chip inside the wearable devices in order to communicate with others. This limits people who have wearables devices but no smartphones, or who do not currently have cellular or wireless services.

Second, messages displayed on the existing types of wearable devices are generally texts and/or graphics, which can be readily understandable by people nearby if they see such messages. There is a need for people to send and receive messages that can be displayed in an encoded way for fun, for privacy concerns, and/or for safety reasons.

Therefore, there is a need in the art to provide systems and methods for improving communication via wearable devices. Accordingly, it is desirable to provide methods and systems that overcome these and other deficiencies of the related art.

### SUMMARY

In accordance with the disclosed subject matter, systems, methods, and computer readable media are provided for communicating among devices.

Disclosed subject matter includes, in one aspect, a method for communicating encoded messages among a plurality of devices. The method includes receiving, at a first device from a second device, a first encoded message including a first configuration of at least one light on the first device indicating a request to communicate; sensing, at the first device, a first sequence of the at least one button pressed on the first device indicating an acceptance of the request; sending, at the first device to the second device, a second encoded message corresponding to the first sequence of the at least one button pressed on the first device indicating the acceptance of the request; receiving, at the first device from the second device, a third encoded message corresponding to a second configuration of the at least one light on the first device; sensing, at the first device, a second sequence of the at least one button pressed on the first device indicating a reply to the third encoded message; sending, at the first device to the second device, a fourth encoded message corresponding to the second sequence of the at least one button pressed on the first device indicating the reply to the third encoded message.

Disclosed subject matter includes, in another aspect, a first device configured to communicate encoded message among a plurality of devices. The first device includes at least one button, at least one light, a sensor, a memory, and a processor. The at least one button and the at least one light are disposed on the first device. The sensor is configured to sense the at least one button being pressed. The memory stores a module. The processor is coupled to the sensor and configured to run the module stored in the memory that is configured to cause the processor to do the following steps. The processor receives, from a second device, a first encoded message including a first configuration of at least one light on the first device indicating a request to communicate. The processor senses a first sequence of the at least one button pressed on the first device indicating an acceptance of the request. The processor sends, to the second device, a second encoded message corresponding to the first sequence of the at least one button pressed on the first device indicating the acceptance of the request. The processor receives, from the second device, a third encoded message corresponding to a second configuration of the at least one light on the first device. The processor senses a second sequence of the at least one button pressed on the first device indicating a reply to the third encoded message. The processor sends, to the second device, a fourth encoded message corresponding to the second sequence of the at least one button pressed on the first device indicating the reply to the third encoded message.

Disclosed subject matter includes, in yet another aspect, a computer readable medium for communicating encoded message among a plurality of devices. The non-transitory computer readable medium includes executable instructions operable to cause a first device to receive, from a second device, a first encoded message including a first configuration of at least one light on the first device indicating a request to communicate. The instructions are further operable to cause the first device to sense, a first sequence of the at least one button pressed on the first device indicating an acceptance of the request. The instructions are further operable to cause the first device to send, to the second device, a second encoded message corresponding to the first sequence of the at least one button pressed on the first device indicating the acceptance of the request. The instructions are further operable to cause the first device to receive, from the second device, a third encoded message corresponding to a second configuration of the at least one light on the first device. The instructions are further operable to cause the first device to sense a second sequence of the at least one button pressed on the first device indicating a reply to the third encoded message. The instructions are further operable to cause the first device to send, to the second device, a fourth encoded message corresponding to the second sequence of the at least one button pressed on the first device indicating the reply to the third encoded message.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be made to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a system for communication via wearable devices in accordance with certain embodiments of the disclosed subject matter.

FIG. 2 illustrates a diagram of a wearable device in accordance with certain embodiments of the disclosed subject matter.

FIG. 3 illustrates a block diagram of a circuit board of a wearable device in accordance with certain embodiments of the disclosed subject matter.

FIGS. 4A-4B illustrate a layout of a circuit board of a wearable device in accordance with certain embodiments of the disclosed subject matter.

FIGS. 5A-5E illustrate various configurations in which a wearable device can communicate with other devices in accordance with certain embodiments of the disclosed subject matter.

FIG. 6 shows a flow chart illustrating a process of communicating between two or more wearable devices in accordance with certain embodiments of the disclosed subject matter.

FIGS. 7A-7R illustrate the user interface of a mobile application associated with a wearable device in accordance with certain embodiments of the disclosed subject matter.

FIG. 8 illustrates a block diagram of a controller included in a wearable device in accordance with certain embodiments of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods, and media that are within the scope of the disclosed subject matter.

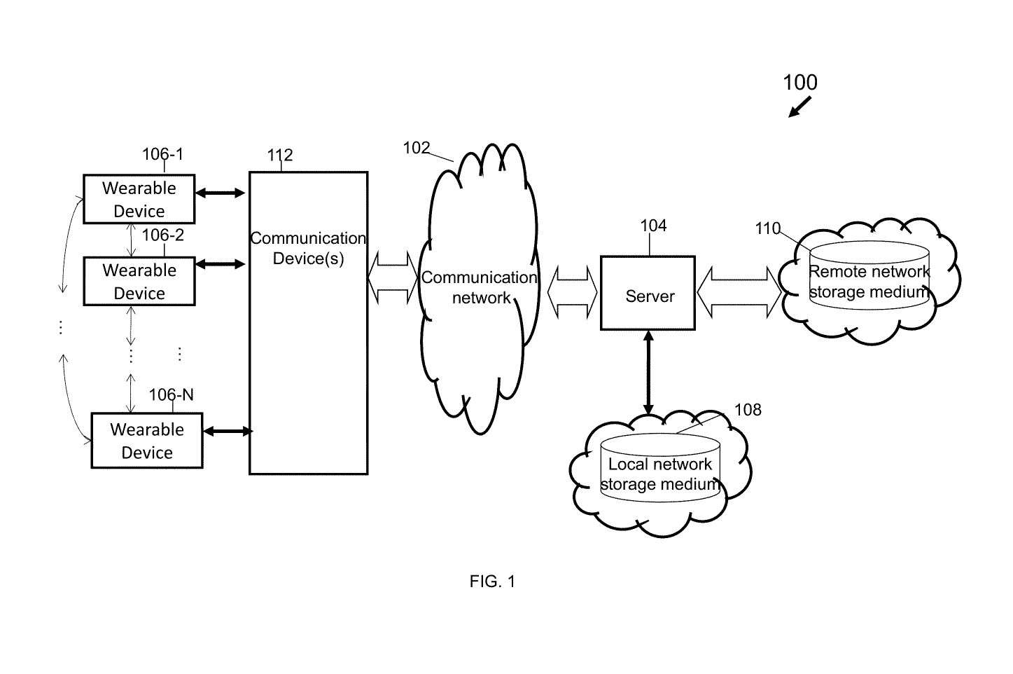

FIG. 1 illustrates a diagram of a system 100 for communication via wearable devices in accordance with certain embodiments of the disclosed subject matter. The system 100 can include a communication network 102, a server 104, at least one user or wearable device 106 (e.g., wearable device 106-1, 106-2, . . . , 106-N), a local network storage medium 108, a remote network storage medium 110, and at least one communication device 112. Some or all components of the system 100 can be coupled directly or indirectly to a communication network 102. The components included in the system 100 can be further broken down into more than one component and/or combined together in any suitable arrangement. Further, one or more components can be rearranged, changed, added, and/or removed.

Each wearable device 106 can communicate with other wearable devices 106 and/or communication devices 112. For example, in one embodiment, a first wearable device 106-1 can directly communicate with a second wearable device 106-2 through a suitable communication medium such as Bluetooth provided the two devices are within the communication range of the communication medium. In another embodiment, the first wearable device 106-1 can communicate with the second wearable device 106-2 via one or more intermediate wearable devices. In this embodiment, even if the distance between the first wearable device 106-1 and the second wearable device 106-2 is beyond the communication range of the communication medium, the two wearable devices can still communicate with each other via the one or more intermediate wearable devices as long as the distance between any two adjacent wearable devices are within the communication range. In yet another embodiment, the wearable device 106 can be paired to a communication device 112 such as a cellphone, and the wearable devices 106 can communicate with other devices through the communication device 112's communication network. The wearable device 106 are explained in more details below.

The communication device 112 can include a desktop computer, a mobile computer, a tablet computer, a cellular device including a smartphone, or any other suitable system that is capable of performing computation and/or communication. The communication device 112 can be coupled to the wearable device 106 for one or more purposes. For example, as discussed above, in some embodiments, a communication device 112, such as a cellphone, can be paired to a wearable device 106, and the paired cellphone can be used as an intermediate device to send and/or receive messages for the wearable device 106. As described in more details below, in some embodiments, users can use some applications in a communication device 112 to change settings of or send notifications to the paired wearable device 106. In some embodiments, a communication device 112, such as a computer, can be connected to a wearable device 106 and update modules and/or instructions stored in the wearable device 106.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the communication network 102 as a single network; however, the communication network 102 can include multiple interconnected networks listed above.

The server 104 can be a single server, a network of servers, or a farm of servers in a data center. The server 104 can be coupled to a network storage system. The network storage system can include two types of network storage devices: a local network storage medium 108 and a remote network storage medium 110. The local network storage medium 108 and the remote network storage medium 110 can each include at least one physical, non-transitory storage medium, flash memory, a magnetic disk drive, an optical drive, a programmable read-only memory (PROM), a read-only memory (ROM), or any other memory or combination of memories. The local network storage medium 108 and the remote network storage medium 110 can be part of the server 104 or can be separated from the server 104.

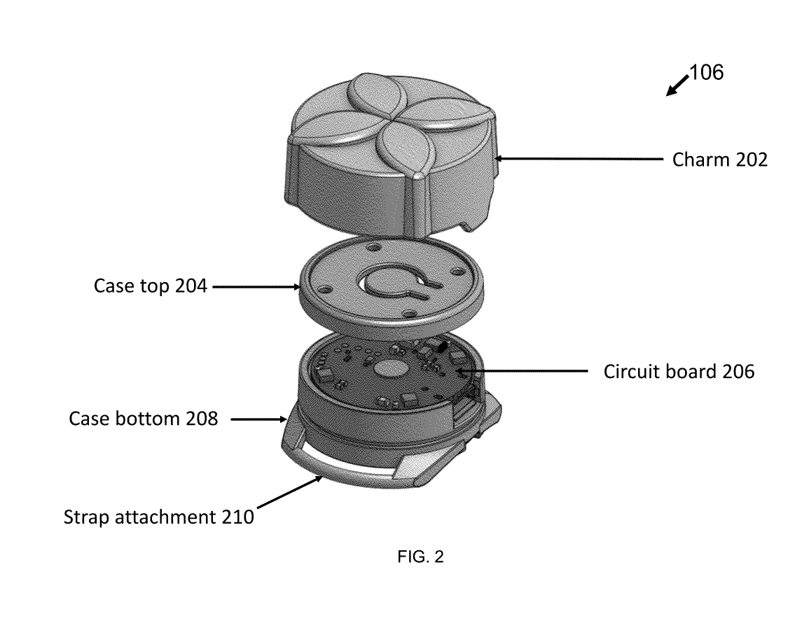

FIG. 2 illustrates a diagram of a wearable device 106 in accordance with certain embodiments of the disclosed subject matter. The wearable device 106 can include a charm 202, a case top 204, a circuit board 206, a case bottom 208, and a strap attachment 210. The components included in the wearable device 106 can be further broken down into more than one component and/or combined together in any suitable arrangement. Further, one or more components can be rearranged, changed, added, and/or removed. For example, in some embodiments, the wearable device 106 may include a component other than a charm for display and/or aesthetics.

The charm 202 can serve as an outer shell for the wearable device 106 and can be created with any suitable patterns and/or shapes for aesthetical and/or functional purposes. The charm 202 can be created with polypropylene, brushed aluminum, or any other suitable material or combination of materials. In some embodiments, the charm 202 is transparent or translucent so that lights from other components can pass through. Additionally or alternatively, the charm 202 can have some openings so that lights from other components can pass through. In some embodiments, when a user presses on the charm 202, it can transfer the pressure to the internal components such as one or more buttons on the circuit board 206; when the one or buttons are pressed, a sensor can sense and send the sensory data for further processing. In some embodiments, the charm 202 can include one or more sensors to sense sensory data. Examples of specific sensory data can include, but are not limited to, force exerted against the surface of the charm 202 by an external environment such as the user; surface temperature of the charm 202; electrical properties of the charm 202; position, velocity, and/or acceleration of the charm 202; or any other suitable measurement or combination of measurements.

The case top 204 can serve as a protective cover for the circuit board 206. In some embodiments, the case top 204 is transparent or translucent so that lights from other component can pass through. Additionally or alternatively, the case top 204 can have some openings so that lights from other components can pass through. In some embodiments, the case top 204 can transfer the force exerted against the surface of the charm 202 to the circuit board 206 for sensing and/or processing.

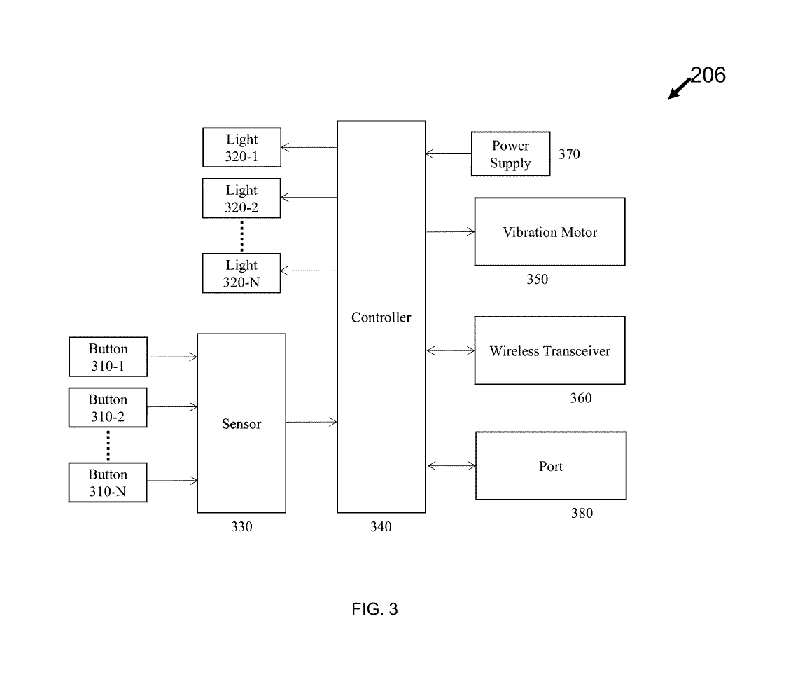

The circuit board 206 hosts several components that handle various functions of the wearable device 106. The components of the circuit board 206 are described in more details below in connection with FIG. 3.

The case bottom 208 can serve as a support for the circuit board 206.

The strap attachment 210 can be used to help a user to carry the wearable device 106. For example, the strap attachment 210 can attach the wearable device 106 to a watchband so that the user can wear the wearable device 106 in the wrist. The strap attachment 210 can be in any suitable shapes or configurations so that the user does not have to wear the wearable device 106 in the wrist. For example, in some embodiments, the strap attachment 210 can be a pin that attaches the wearable device 106 to the user's clothes.

In some embodiments, the charm 202, the case top 204, the case bottom 208, and the strap attachment 210 can be interchangeable with different styles. Users can remove the circuit board 206 from one wearable device 106 and put it in another wearable device 106. In some embodiments, various components in the wearable device 106 can be integrated into a single component. For example, the charm 202, the case top 204, the circuit board 206, the case bottom 208, and the strap attachment 210 can be all integrated together as one piece.

FIG. 3 illustrates a block diagram of a circuit board 206 of a wearable device 106, according to some embodiments of the disclosed subject matter. The circuit board 206 includes at least one button 310 (e.g., button 310-1, 310-2, . . . , 310-N), at least one light 320 (e.g., light 320-1, 320-2, . . . , 320-N), a sensor 330, a controller 340, a vibration motor 350, a wireless transceiver 360, a power supply 370, and a port 380. The components included in the circuit board 206 can be further broken down into more than one component and/or combined together in any suitable arrangement. Further, one or more components can be rearranged, changed, added, and/or removed. As another example, although FIG. 3 shows the at least one light 320 is located on the circuit board, the light 320 can be located on the surface of the charm 202, the case top 204, the case bottom 208, and/or any other suitable location. Similarly, other components shown in FIG. 3 can also locate at any other suitable location of the wearable device 106.

Referring to the at least one button 310, a user can press the at least one button 310 in different sequences to indicate different messages. In some embodiments, pressing the at least one button 310 for a different numbers of times can indicate different messages. For example, pressing the at least one button 310 three times can mean different things from pressing the at least one button 310 five times. In some embodiments, pressing the at least one button 310 at different frequencies can indicate different messages. For example, a quick double-tap on the at least one button 310 can mean different things from pressing the at least one button 310 twice with a relatively long time interval between the two pressings. In some embodiments, pressing the at least one button 310 at different durations can indicate different messages. For example, long pressing the at least one button 310 can mean different things from quick pressing the at least one button 310. If the circuit board 206 includes more than one button 310, pressing the more than one button 310 in different orders can indicate different messages. The user can apply some or all methods described here to press the at least one button 310 to indicate messages.

The pressing of the at least one button 310 can be sensed by the sensor 330, which can send sensory data to the controller 340 for processing.

Referring to the at least one light 320, the light 320 can be an LED or any other suitable light source. The circuit board 206 can include any suitable numbers of the light 320, and the light 320 can be arranged in a line, a circle, a rectangle, or any other suitable arrangement. The light 320 can be controlled by the controller 340 to flash in different configurations, sequences, and/or combinations thereof to indicate different messages. In some embodiments, the light 320 can display more than one color, and different permutations and/or combinations of colors can mean different things. In some embodiments, flashing the light 320 for different numbers of times can indicate different messages. For example, flashing the light 320 twice can mean different things from flashing the light 320 four times. In some embodiments, flashing the light 320 at different frequencies can indicate different messages. For example, flashing the light 320 three times with short time intervals can mean different things from flashing the light 320 three times with long time intervals. In some embodiments, flashing the light 320 at different durations can indicate different messages. For example, the light 320 is turned on for a long time can mean different things from the light 320 is turned on for a short time. If the circuit board 206 includes more than one light 320, flashing the more than one light 320 in different orders can indicate different messages. The light 320 can be flashed by some or all methods described here to indicate different messages.

Referring to the sensor 330, the sensor 330 can sense sensory data such as force exerted against the at least one button 310 by an external environment such as users. The sensor 330 senses the sensory data and sends the sensory data to the controller 340 for processing. The circuit board 206 can include one or more sensors 330. In some embodiment, if the circuit board 206 includes more than one button 310, each button 310 can have a corresponding sensor 330. The sensor 330 can be a touch sensor (e.g., a resistive touch sensor and/or a capacitive touch sensor) or any other suitable sensors or combination of sensors.

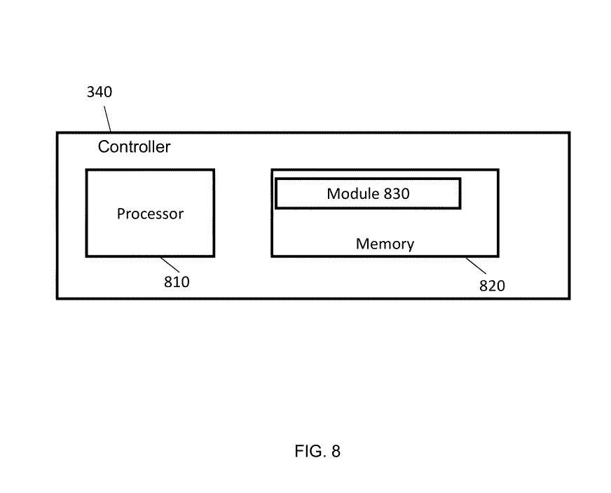

Referring to the controller 340, the controller 340 can receive the sensory data from the sensor 330 and translate the sensory data into messages. The controller can send the translated messages to other wearable device 106 and/or the communication device 112 through the wireless transceiver 360. The controller 340 can receive messages from other wearable device 106 and/or the communication device 112 through the wireless transceiver 360, and configure the at least one light 320 and/or the vibration motor 350. The controller 340 can also receive instructions and/or programs from the port 380. The controller 340 are described in more details below in connection with FIG. 8.

Referring to the vibration motor 350, the vibration motor 350 can receive a command signal from the controller 340 and generate vibrations. The command signal can be an electrical signal (for example, electrical current and/or electrical voltage), hydraulic liquid pressure, or any other suitable energy form or combination of energy forms. The vibration motor 350 converts the command signal into motions and can change the quantity, intensity, duration, and/or frequency of the vibrations based on the variance of the command signal. The circuit board 206 can include one or more vibration motors 350.

Referring to the wireless transceiver 360, the wireless transceiver 360 can represent a communication interface between the wearable device 106 and other wearable devices 106 and/or communication devices 112. For example, a first wearable device 106-1 can send messages to a second wearable device 106-2 via the wireless transceiver 360 and receive messages from the second wearable device 106-2 via the wireless transceiver 360. The wireless transceiver 360 enables bidirectional communication between the wearable device 106 and other wearable devices 106 and/or communication devices 112 via any wireless connection including, without limitation, Bluetooth, WiFi, cellular, and/or other wireless standards. In some embodiments, the wireless transceiver 360 can also enable bi-directional communication between the wearable device 106 and other wearable device 106 and/or communication device 112 via the network 102. In some embodiments, the wireless transceiver 360 can serve as a configuration interface between the wearable device 106 and a communication device 112. For example, users can write some programs on the communication device 112 such as a desktop computer, and download the programs to the wearable device 106 through the wireless transceiver 360.

Referring to the power supply 370, the power supply 370 provides power to one or more other components, such as the at least one light 320, the sensor 330, the controller 340, the vibration motor 350, the wireless transceiver 360, and/or the port 380. In some embodiments, the power supply 370 can be a battery source. In some embodiments, the power supply 370 can provide alternating current (AC) and/or or direct current (DC) power via an external power source.

Referring to the port 380, the port 380 can serve as a configuration interface between the wearable device 106 and a communication device 112. For example, users can write some programs on the communication device 112 such as a desktop computer, and download the programs to the wearable device 106 through the port 380. The port 380 can be a micro-USB port, or any other suitable type of port.

In some embodiments, the circuit board 206 can include additional components. For example, the circuit board 206 can include a reset button, and when users press on the reset button, the state of the controller 340 can be reset. In some embodiments, the circuit board 206 can include one or some of the following components: an accelerometer, which can determine how the wearable device 106 is moving; a gyroscope, which can determine the orientation of the wearable device 106 in space; a magnetometer, which can determine the position of the wearable device 106 relative to the Earth; a speaker that can play sound recordings; a microphone that can make sound recordings; and a display that can show text, pictures, and/or videos. The circuit board 206 may also include any other suitable component or combination of components.

FIG. 8 is a block diagram of the controller 340 included in a wearable device 106 in accordance with some embodiments of the disclosed subject matter. The controller 340 includes a processor 810 and a memory 820. The memory 820 includes a module 830. The controller 340 may include additional modules, fewer modules, or any other suitable combination of modules that perform any suitable operation or combination of operations.

In some embodiments, the processor 810 can include one or more cores and can accommodate one or more threads to run various applications and modules. The software can run on the processor 810 capable of executing computer instructions or computer code. The processor 810 might also be implemented in hardware using an application specific integrated circuit (ASIC), programmable logic array (PLA), field programmable gate array (FPGA), or any other integrated circuit.

The memory 820 can be a non-transitory computer readable medium, flash memory, a magnetic disk drive, an optical drive, a PROM, a ROM, or any other memory or combination of memories.

The processor 810 can be configured to run the module 830 stored in the memory 820 that is configured to cause the processor 810 to perform various steps that are discussed in the disclosed subject matter. For example, the module 830 can be configured to cause the processor 810 of a first wearable device 106-1 to receive, from a second wearable device 106-2, a first encoded message comprising a first configuration of at least one light 320 on the first wearable device 106-1 indicating a request to communicate. The module 830 can be configured to cause the processor 810 to sense a first sequence of the at least one button 310 pressed on the first wearable device 106-1 indicating an acceptance of the request. The module 830 can be configured to cause the processor 810 to send, to the second wearable device 106-2, a second encoded message corresponding to the first sequence of the at least one button 310 pressed on the first wearable device 106-1 indicating the acceptance of the request. The module 830 can be configured to cause the processor 810 to receive, from the second wearable device 106-2, a third encoded message corresponding to a second configuration of the at least one light 320 on the first wearable device 106-1. The module 830 can be configured to cause the processor 810 to sense a second sequence of the at least one button 310 pressed on the first wearable device 106-1 indicating a reply to the third encoded message. The module 830 can be configured to cause the processor 810 to send, to the second wearable device 106-2, a fourth encoded message corresponding to the second sequence of the at least one button 310 pressed on the first wearable device 106-1 indicating the reply to the third encoded message.

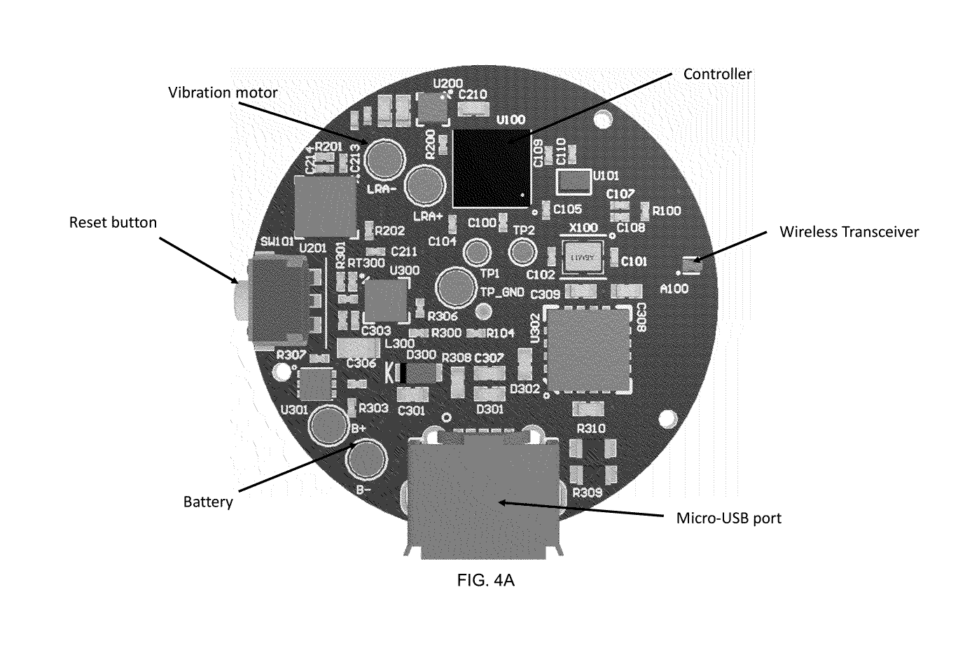

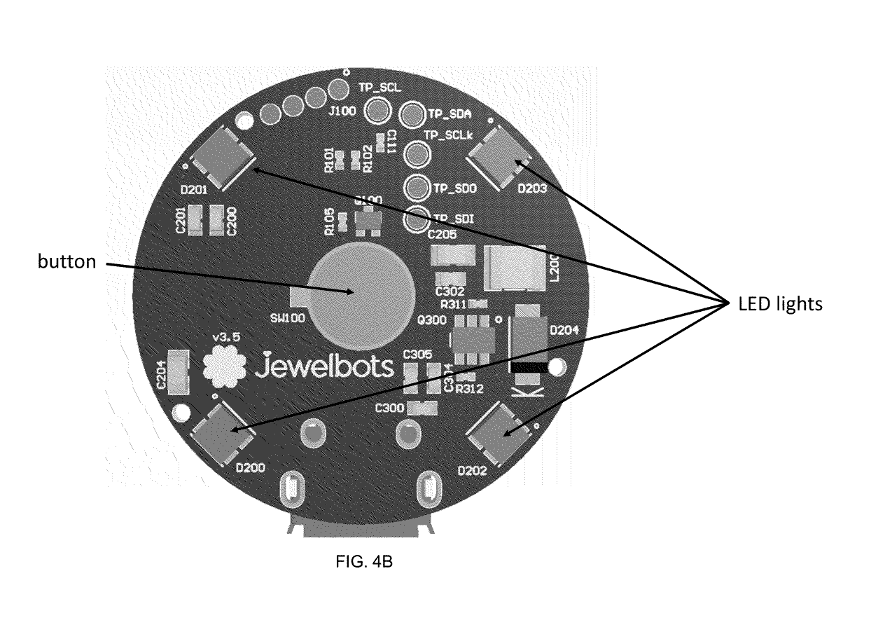

FIGS. 4A-4B show a layout of the circuit board 206 in accordance with certain embodiments of the disclosed subject matter. FIG. 4A shows that one side of the circuit board 206 includes components such as a battery connector, a micro-USB port, a wireless transceiver, a controller, a vibration motor connector, and a reset button. In this example, the battery and the vibrator can locate outside the circuit board 206. For example, the battery and/or the vibration motor can locate at the charm 202 or any other suitable location of the wearable device 106. FIG. 4B shows that the other side of the circuit board 206 includes components such as four lights and one button. The layout of the circuit board 206 shown in FIGS. 4A-B is a non-limiting example, and components can be located at any suitable locations on the circuit board 206. Further, although FIG. 4B shows four lights and one button, any other suitable number of light and/or button can be included in the circuit board 206.

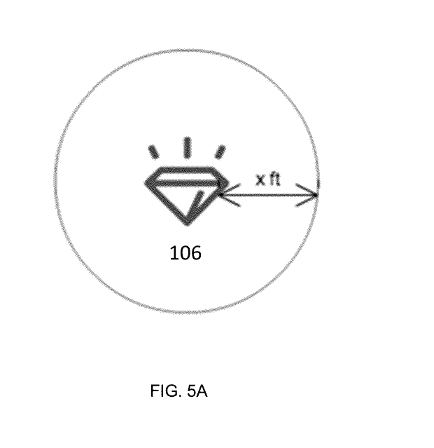

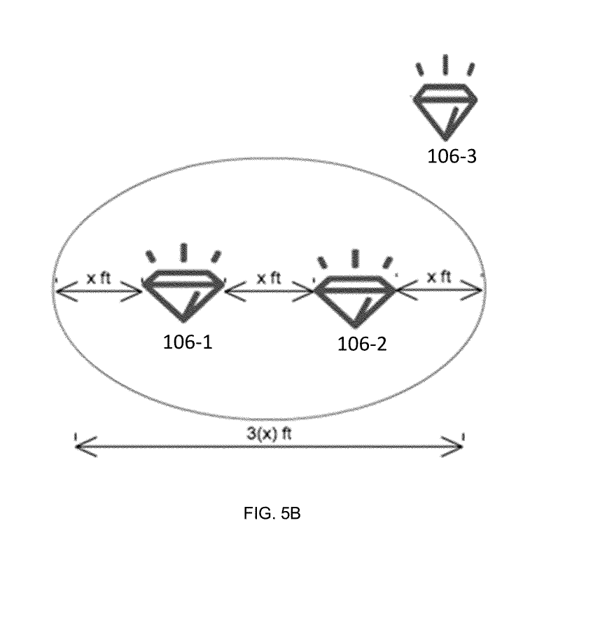

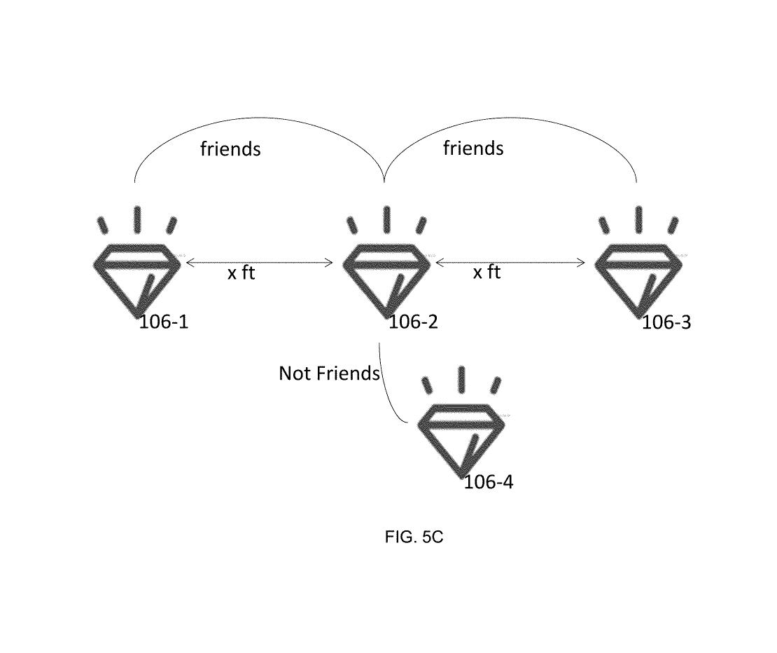

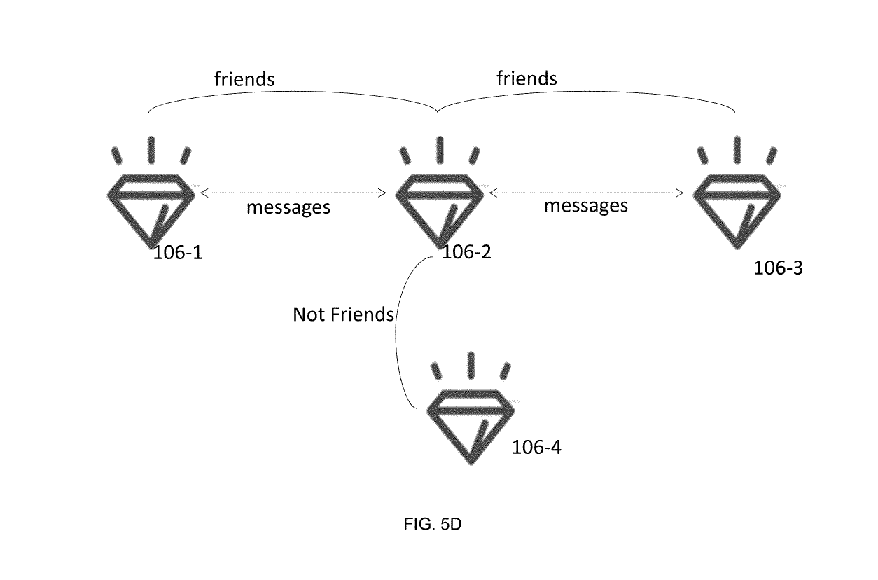

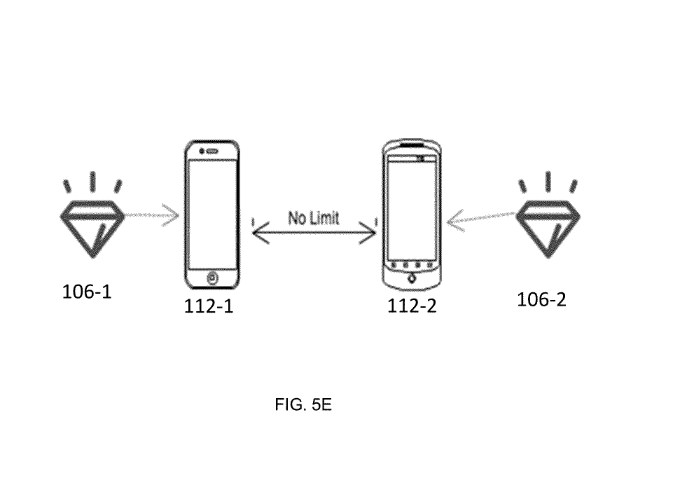

As discussed above, each wearable device 106 can include a wireless transceiver 360. FIG. 5A illustrates that the wireless transceiver 360 enables the wearable device 106 to communicate with other devices within the communication range of the wireless transceiver 360. In some embodiments, the communication range can be anywhere from approximately 30 ft to 200 ft, or any other suitable range.

FIG. 5B shows that the distance between a first wearable device 106-1 and a second wearable device 106-2 does not exceed the communication range, so the two devices can communicate with each other. On the contrary, because a third wearable device 106-3 is located farther than the communication range from either the first wearable device 106-1 or the second wearable device 106-2, the third wearable device 106-3 cannot directly communicate with the wearable device 106-1 or the second wearable device 106-2.

FIG. 5C shows that the first wearable device 106-1 can directly communicate with the second wearable device 106-2 because they are within the communication range. Similarly, the second wearable device 106-2 can directly communicate with the third wearable device 106-3 because they are within the communication range. Further, in one embodiment, the first wearable device 106-1 can communicate with the third wearable device 106-3 via the second wearable communication device 106-2. In this embodiment, the second wearable device 106-2 essentially behaves as an intermediate node to relay messages between the first wearable device 106-1 and the third wearable device 106-3. In some embodiments, a wearable device 106 can only serve as an intermediate node for two or more other wearable devices if that wearable device 106 is a friend of the two or more other wearable devices. For example, in FIG. 5C, although the distance between the second wearable device 106-2 and the first wearable device 106-1 is within the communication range, and the distance between the second wearable device 106-2 and a fourth wearable device 106-4 is within the communication range, the first wearable device 106-1 cannot communicate with the fourth wearable device 106-4 via the second wearable device 106-2 because the second wearable device 106-2 is not friend of the fourth wearable device 106-4. As discussed in more details below, one way for two wearable devices 106 to be authorized as friends is to pair them together.

FIG. 5D shows that, in some embodiments, two wearable devices 106 can exchange messages only if they have been authorized as friends. For example, in FIG. 5D, the second wearable device 106-2 is located within the communication range from the first wearable device 106-1, the second wearable device 106-2, and the fourth wearable device 106-4; however, the second wearable 106-2 can only exchange messages with the first wearable device 106-1 and the third wearable device 106-3 but not the fourth wearable device 106-4 because the second wearable device 106-2 is only a friend of the first wearable device 106-1 and the third wearable device 106-3 but not of the fourth wearable device 106-4.

In some embodiments, a wearable device 106 can be paired to a communication device 112 such as a cellphone, and the wearable devices 106 can communicate with other devices through the communication device 112's communication network. For example, in FIG. 5E, the first wearable device 106-1 is paired to the first cellphone 112-1, and the second wearable device 106-2 is paired to the second cellphone 112-2. When the first wearable device 106-1 sends a message to the second wearable device 106-2, the message can be sent through the following steps. First, the first wearable device 106-1 sends the message to the first cellphone 112-1 via a first communication medium such as Bluetooth, WiFi, or any other suitable medium. Second, the first cellphone 112-1 sends the received message to the second cellphone 112-2 thought a communication network such as a cellular network, a WiFi network, or any other suitable network. Third, the second cellphone 112-2 sends the received message to the second wearable device 106-2 via a second communication medium such as Bluetooth, WiFi, or any other suitable medium. The first communication medium and the second communication medium can be the same or different so long as these communication media are supported by the respective wireless transceivers 360 in the first wearable device 106-1 and the second wearable device 106-2. In the situation illustrated by FIG. 5E, the first wearable device 106-1 can communicate with the second wearable device 106-2 even if the two wearable devices are located beyond the communication range of the wireless transceiver 360 because the two wearable devices can use the network connecting the first cellphone 112-1 and the second cellphone 112-2.

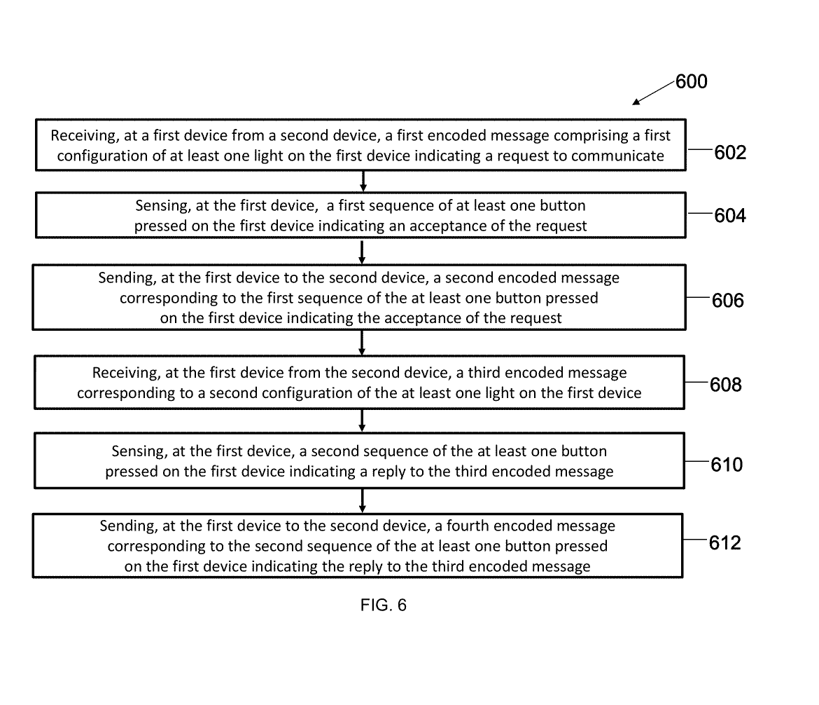

FIG. 6 is a flow chart illustrating a process 600 of communicating between two or more wearable devices 106 in accordance with certain embodiments of the disclosed subject matter. In some embodiments, the process 600 can be modified by, for example, having steps rearranged, changed, added, and/or removed.

At step 602, the first wearable device 106-1 receives a first encoded message from the second wearable device 106-2. The first encoded messages indicates a request from the second wearable device 106-2 to communicate and is represented, at least partially, by a first configuration of the at least one light 320 on the first wearable device 106-1. A configuration of the at least one light 320 can include flashing a corresponding sequence of the at least one light 320. Users can program their wearable devices 106-1 so that flashing different sequences of the at least one light 320 can correspond to different messages. In some embodiments, flashing the at least one light 320 for different numbers of times can indicate different messages. For example, flashing the at least one light 320 twice can mean different things from flashing the at least one light 320 four times. In some embodiments, flashing the at least one light 320 at different frequencies can indicate different messages. For example, flashing the at least one light 320 three times with short time intervals can mean different things from flashing the at least one light 320 three times with long time intervals. In some embodiments, flashing the at least one light 320 at different durations can indicate different messages. For example, the at least one light 320 is on for a long time can mean different things from the at least one light 320 is on for a short time. If the circuit board 206 includes more than one light 320, flashing the more than one light 320 in different orders can indicate different messages. Further, each light 320 can display more than one color, and different colors can mean different things. The configuration of the at least one light 320 can include different ways to flash the as least one light 320 as discussed here. Users can agree upon beforehand how an encoded message can be represented by a configuration of the at least one light 320 and program their wearable devices 106 accordingly.

In some embodiments, prior to receiving the first encoded message from the second wearable device 106-2, the first wearable device 106-1 needs to be additionally paired to the second wearable device 106-2 as friends. A non-limiting method to pair two wearable devices 106 can include the following steps. First, place the two devices within the communication range of the wireless transceiver 360. Second, press the at least one button 310 of the first wearable device 106-1 and the at least one button 310 of the second wearable device 106-2 at approximately the same time. Third, hold the at least one button 310 of the first wearable device 106-1 and the at least one button 310 of the second wearable device 106-2 for at least a certain period of time. Forth, release the at least one button 310 of the first wearable device 106-1 and the at least one button 310 of the second wearable device 106-2 at approximately the same time. A similar method can also be applied to pair more than two wearable devices by pressing, holding, and releasing the buttons of each wearable device that is going to be paired at approximately the same time. Any other suitable method can also be used to pair two or more wearable devices. In some embodiments, the at least one light 320 on each wearable device 106 can display more than one color, and the users can choose to assign a color to the pairing devices. As a non-limiting example, the first wearable device 106-1 and the second wearable device 106-2 can each have four lights, and each light can display four colors including red, yellow, green, and blue. When users press the buttons 310 associated with the first wearable device 106-1 and the second wearable devices 106-2 at approximately the same time during the paring mode, all lights of the first wearable device 106-1 and the second wearable device 106-2 will cycle through the four colors in an order such as red-yellow-green-blue. If the users release the buttons while the lights are flashing green color, the two devices are paired as green friends. The process 600 then proceeds to step 604.

At step 604, a first user of the first wearable device 106-1 sees the first configuration of the at least one light 320 and understands that it indicates a request from the second wearable device 106-2 to communicate. For example, the users may have already agreed upon that a quick double flash of the at least one light 320 means a request to communicate, so when the first users sees a quick double flash of the at least one light 320 on the first wearable device 106-1, he or she understands it indicates a request to communicate. The first user can decide whether or not to accept the request. If the first user decides to accept the request, he or she can respond by pressing a first sequence of the at least one button 310 on the first wearable device 106-1, where the first sequence of pressing the at least one button 310 indicates an acceptance of the request. The first user can press the at least one button 310 in different sequences to indicate different messages. In some embodiments, pressing the at least one button 310 for different numbers of times can indicate different messages. For example, pressing the at least one button 310 three times can mean different things from pressing the at least one button 310 five times. In some embodiments, pressing the at least one button 310 at different frequencies can indicate different messages. For example, a quick double-tap on the at least one button 310 can mean different things from pressing the at least one button 310 twice with a relatively long time interval between the two pressings. In some embodiments, pressing the at least one button 310 at different durations can indicate different messages. For example, long pressing the at least one button 310 can mean different things from quick pressing the at least one button 310. If the circuit board 206 includes more than one button 310, pressing the more than one button 310 in different orders can indicate different messages. The first user can apply some or all methods described here to press the button 310 to indicate messages. As a non-limiting example, if the users have agreed upon that flashing the at least one light 320 three times indicate an acceptance, the first user can then press the at least one button 310 three times. The sensor 330 of the first wearable device 106-1 senses the first sequence of the at least one button pressed. The process 600 then proceeds to step 606.

At step 606, the first wearable device 106-1 sends a second encoded message to the second wearable device 106-2, and the second encoded message corresponds to the first sequence of the at least one button 310 pressed on the first wearable device 106-land indicates the first user's acceptance of the request to communicate. For example, once the second wearable device 106-2 receives the second encoded message, the at least one light 320 on the second wearable device 106-2 may flash three times, and the second user understands that the first user accepts the request. The process 600 then proceeds to step 608.

At step 608, the first wearable device 106-1 receives, from the second device, a third encoded message corresponding to a second configuration of the at least one light 320 on the first wearable device. For example, the second configuration of the at least one light 320 can be two long flashes followed by a short flash. The process 608 then proceeds to step 610.

At step 610, the first user sees the second configuration of the at least one light 320 and understands what it means. For example, the users may have agreed upon that the sequence of two long flashes followed by a short flash means “let's meet in the locker room.” The first user can respond by pressing a second sequence of the at least one button 310 on the first wearable device 106-1, where the second sequence of pressing the at least one button 310 indicates a reply to the third encoded message. For example, the first user can press the at least one button 310 five times to indicate, “I will be there in five minutes.” The sensor 330 of the first wearable device 106-1 senses the second sequence of the at least one button 310 pressed. The process 600 then proceeds to step 612.

At step 612, the first wearable device 106-1 sends a fourth encoded message to the second wearable device 106-2, and the fourth encoded message corresponds to the second sequence of the at least one button 310 pressed on the first wearable device 106-land indicates the reply to the third encoded message. For example, the fourth encoded message can correspond to flashing the at least one light 320 five times on the second wearable device 106-2.

In some embodiments, once the first wearable device 106-1 and the second wearable device 106-2 are paired as friends, they do not need to first send a request to communicate and can directly exchange encoded messages. In some embodiments, the first wearable device 106-1 and the second wearable device 106-2 neither need to be paired as friends nor need to first request to communicate before they can directly exchange encoded messages.

In some embodiments, when the wearable device 106 receives an encoded message, in addition to displaying a configuration of at least one light 320 on the wearable device 106, the vibration motor 350 can also have a sequence of one or more vibrations. The user can set the quantity, intensity, duration, and/or frequency of the vibrations based on the encoded message received.

In some embodiments, when the wearable device 106 receives an encoded message, the corresponding configuration of at least one light 320 on the wearable device 106 can also indicate the source of the encoded message. As a non-limiting example, the first user can set the second wearable device 106-2 as a “blue” friend. When the first wearable device 106-1 receives a message from the second wearable device 106-2, the at least one light 320 on the first wearable device 106-1 can flash in blue color only so that the first user will know the message is from a “blue” friend such as the second wearable device 106-2. Alternatively, when the first wearable device 106-1 receives a message from the second wearable device 106-2, the at least one light 320 on the first wearable device 106-1 can first flash in blue color to indicate the message is from a “blue” friend then flash a sequence to indicate the content of the message. Any other suitable method can also be used to indicate the source of the message.

In some embodiments, the first wearable device 106-1 can sense a nearby second wearable device 106-2 and send an encoded message corresponding to a configuration of at least one light 320 on the nearby second wearable device 106-2 indicating a request to communicate.

In some embodiments, one wearable device can send messages to more than one other wearable devices at the same time. For example, when the first user presses the at least one button 310 on the first button at a sequence, the sensor 330 of the first wearable device 106-1 can sense the sequence of the at least one button 310 pressed on the first wearable device 106-1 and send a corresponding encoded message to both the second wearable device 106-2 and the third wearable device 106-3.

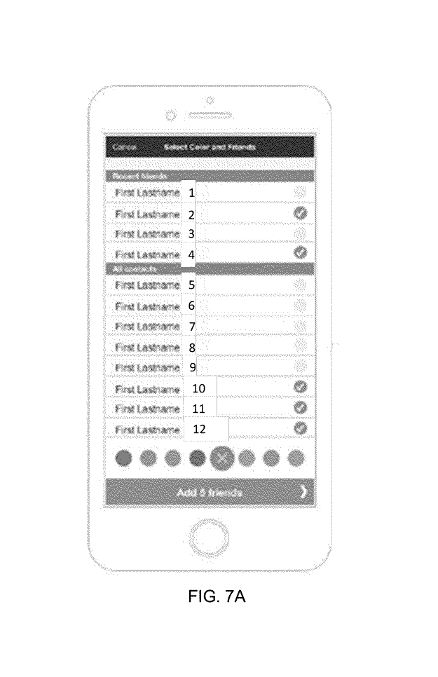

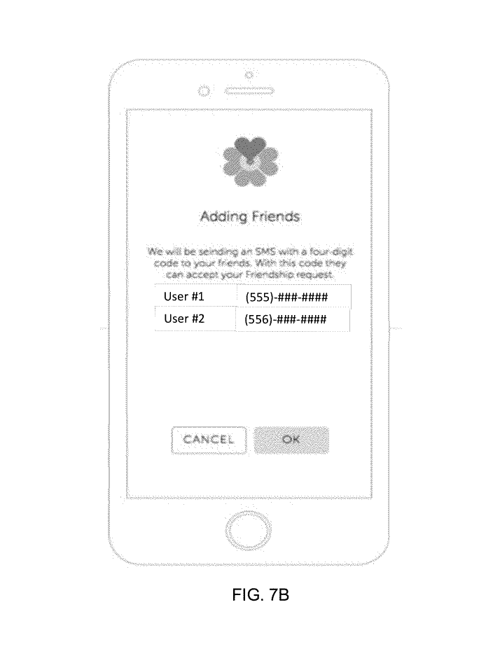

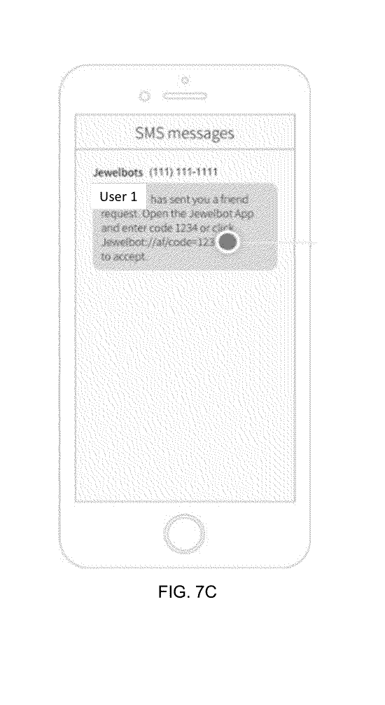

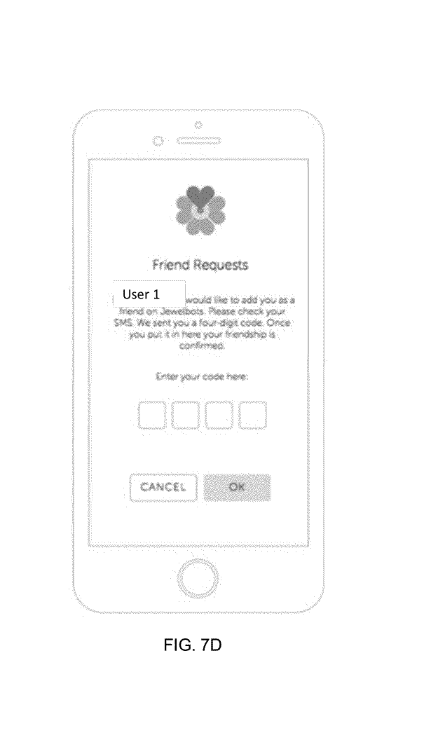

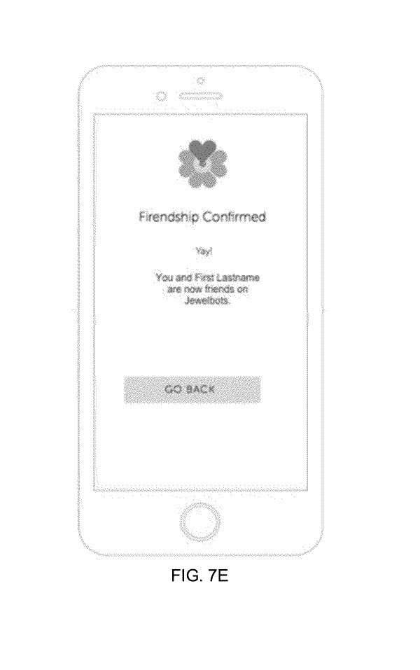

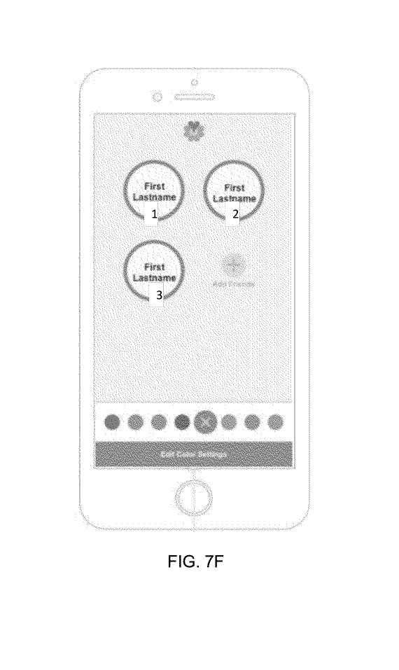

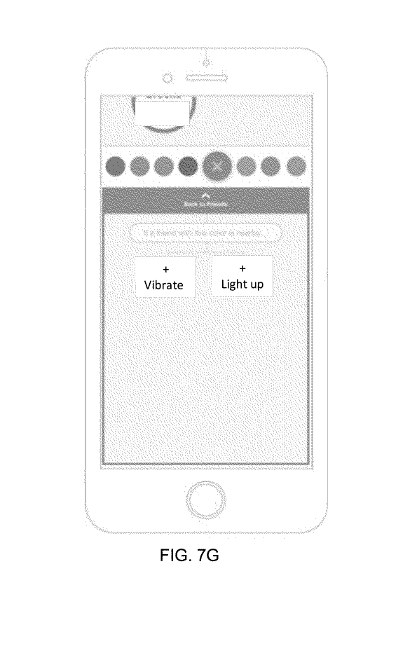

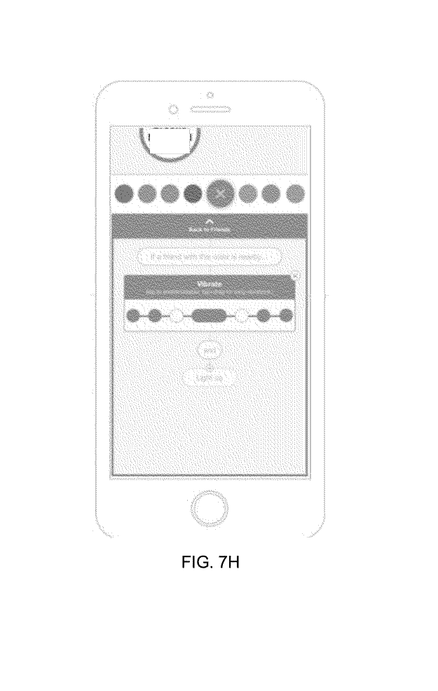

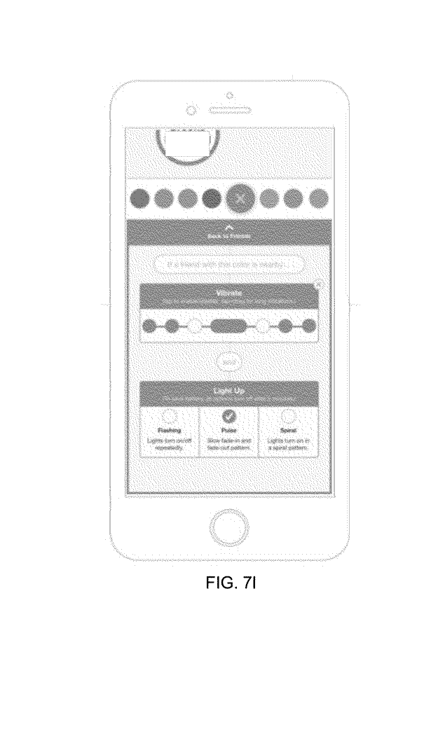

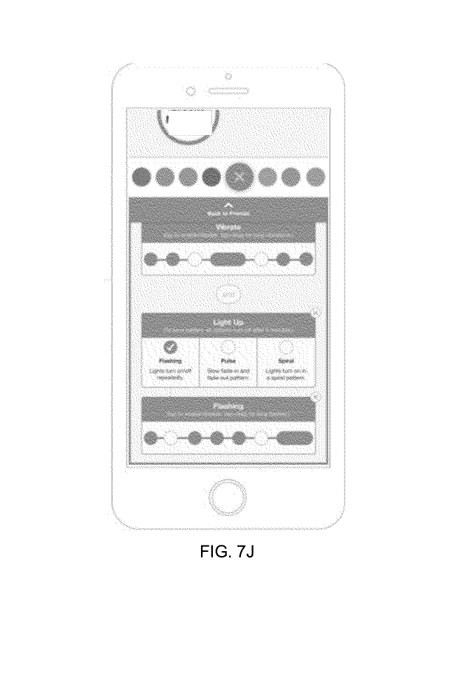

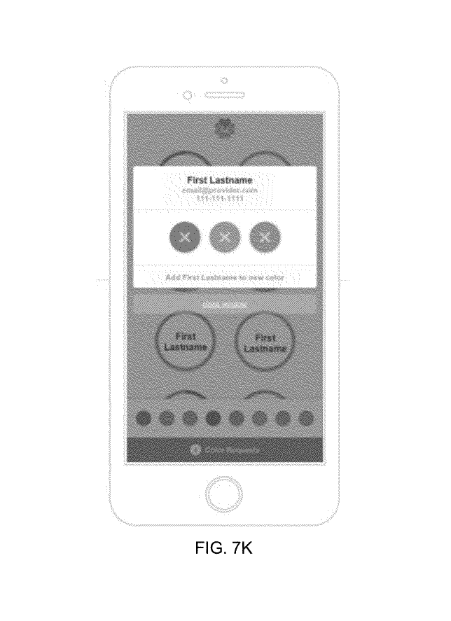

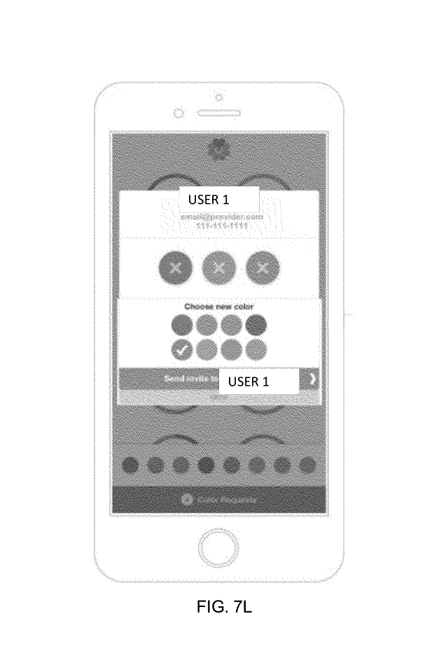

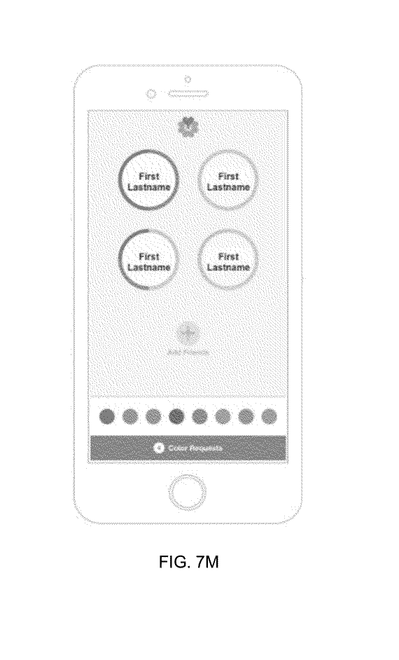

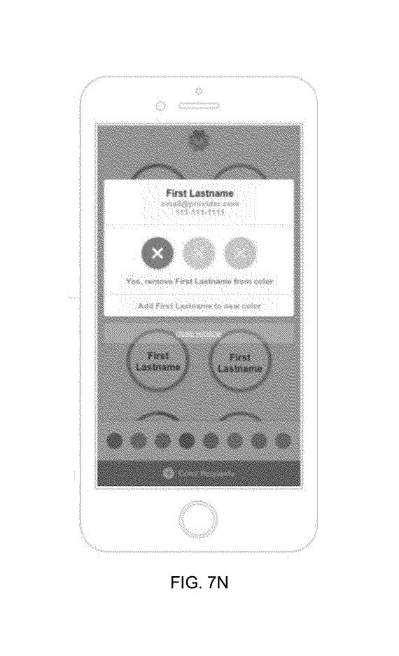

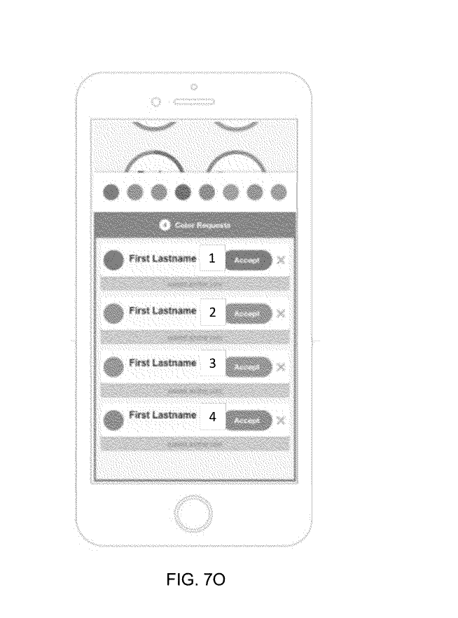

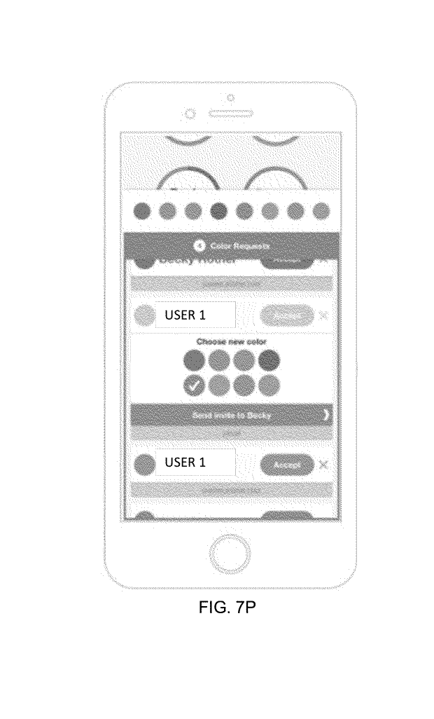

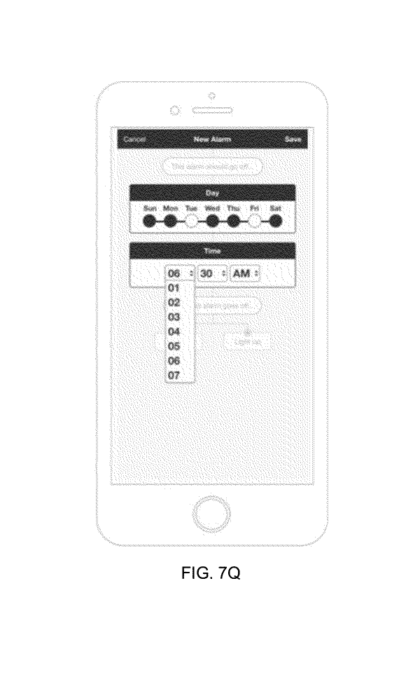

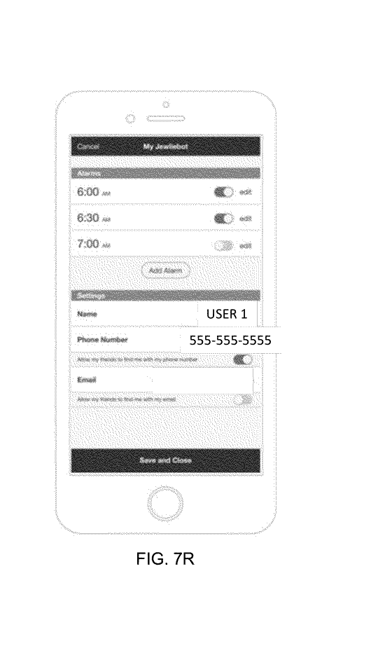

The wearable device 106 can be paired to a communication device 112 through the wireless transceiver 360. For example, FIGS. 7A-7R show that a cellphone can be paired to the wearable device 106, and users can use a mobile application running on the paired cellphone to help display messages received at the wearable device 106 and/or determine various settings associated with the wearable device 106. The embodiments shown in FIGS. 7A-7R are not limiting. Further, in some embodiments, the user can also receive messages and/or change settings through online websites.

For example, FIG. 7A shows that, in some embodiments, the user can select one or more people from his or her cellphone's contact list and send out friendship requests to the one or more people. If the one or more people also have wearable devices 106 and accept the friendship requests, then the user can communicate with the one or more people using the wearable devices 106. In some embodiments, the user can also import contact list from the user's social media/network and send out friendship requests to one or more people from the contact list of the user's social media/network. In FIG. 7A, when the user chooses a second user and send out a friendship request to the second user, he or she can also assign a color to the second user. Any future encoded messages from the second user can by displayed in the assigned color.

FIG. 7B shows that friend requests can be sent using short message service (SMS) with a confirmation code such as a four-digit code. When the first wearable device 106-1 receives a friend request, such request can be displayed on the paired cellphone. For example, FIG. 7C shows that the first wearable device 106-1 receives a friend request from User 1, and such request can be accepted by opening a mobile application and entering the confirmation code received. In some embodiments, the user can also choose to reply the friend request by using the wearable device 106 by pressing the at least one button 310 on the wearable device 106 in certain sequence. FIG. 7D shows a user interface that the user can choose to accept a request by entering the confirmation code. FIG. 7E shows an interface informing the user the friendship request has been confirmed.

FIGS. 7F-7J show various interfaces of changing settings associated with a friend and/or a color group FIG. 7F shows that the user can edit certain behaviors of his or her wearable device 106 when it receives a message from a friend. FIG. 7G shows two categories of such behaviors: how the wearable device 106 vibrates and how the wearable device 106 lights up. FIG. 7H shows the user can choose whether the wearable device 106 will vibrate and how to vibrate when the wearable device 106 receives a message from the friend. FIGS. 7I-7J show the user can choose whether the wearable device 106 will light up and how to light up when the wearable device 106 receives a message from the friend. FIG. 7I shows that the user can choose a pulse pattern for the at least one light 320, where the at least one light 320 slowly have fade-in and fade-out pattern. FIG. 7J shows that the user can choose another pattern for the at least one light 320, where the at least one light 320 is turned on and off repeatedly. In some embodiments, the at least one light 320 can also be configured to turn on in a spiral pattern or any other suitable pattern or combination of patterns.

FIG. 7K shows that the user can add a friend to a color group. FIG. 7L shows that the user can send a request to USER 1 in order to add USER 1 to the color group. FIG. 7M shows an exemplary interface when the request to add USER 1 to the color group is pending. FIG. 7N shows that the user can remove a friend from a color group. FIG. 7O displays several requests received from others, and the user can choose to accept.

FIG. 7P shows that the user can use the mobile application to choose a new color for USER 1. For example, USER 1 was chosen as a “blue” friend, and the user can now switch USER 1 to a “red” friend. In one embodiment, when the user receives a message from USER 1 at the wearable device 106, the at least one light 320 will now flash red light to indicate the message is from a “red” friend. In some embodiments, the user can also use the mobile to change other settings, such as how the vibration motor 350 vibrates when the wearable device 106 receives a message.

FIG. 7Q shows that the user can set an alarm using the mobile application. In FIG. 7Q, the user sets an alarm at 6:30 AM on Tuesday. As a result, every Tuesday at 6:30 AM, the user will receive an encoded message at his or her wearable device 106. FIG. 7R displays all alarm settings associated with USER 1.

A user can also customize and/or update his or her wearable device 106 by writing programs. In one embodiment, the user can write such programs on a communication device 112 such as a computer using open source Arduino Integrated Development Environment (IDE). Any other suitable language and/or platform can also be used. The user can then connect his or her wearable device 106 with the computer through the port 380, and the instructions and/or modules stored on the processor 810 and/or the memory 820 can be updated. In some embodiments, the user can update how his or her wearable device 106 displays when a request to communicate is received. For example, when the wearable device 106 receives a request, under the default setting, the wearable device 106 may flash the at least one light 320 twice; the user may update this setting by flashing the at least one light 320 four times. In some embodiment, the user can also program his or her wearable device 106 to receive encoded messages for certain events. Non-limiting examples of those events include having a new follower on the user's Twitter account, receiving a phone call from the user's friend, the user's favorite TV show is about to start, or whether or not it will rain at 9 AM.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for communicating encoded messages among a plurality of devices, comprising:
receiving, at a first device from a second device, a first encoded message comprising a first configuration of at least one light on the first device indicating a request to communicate;
sensing, at the first device, a first sequence of at least one button pressed on the first device indicating an acceptance of the request;
sending, at the first device to the second device, a second encoded message corresponding to the first sequence of the at least one button pressed on the first device indicating the acceptance of the request;
receiving, at the first device from the second device, a third encoded message corresponding to a second configuration of the at least one light on the first device;
sensing, at the first device, a second sequence of the at least one button pressed on the first device indicating a reply to the third encoded message; and
sending, at the first device to the second device, a fourth encoded message corresponding to the second sequence of the at least one button pressed on the first device indicating the reply to the third encoded message.

2. The method of claim 1, wherein at least one of the first configuration or the second configuration of the at least one light on the first device comprises a plurality of colors.

3. The method of claim 1, wherein at least one of the first encoded message or the third encoded message further comprises a third sequence of one or more vibrations of the first device;

4. The method of claim 1, further comprising:
sensing, at the first device, a nearby third device; and
sending, at the first device to the nearby third device, a fifth encoded message corresponding to a third configuration of at least one light on the nearby third device indicating a second request to communicate.

5. The method of claim 1, further comprising receiving, at the first device, instructions from a communication device that are configured to update at least one of the first configuration or the second configuration of the at least one light on the first device.

6. The method of claim 1:
wherein receiving the first encoded message comprising the first configuration of the at least one light on the first device further comprises flashing, on the first device, a first corresponding sequence of the at least one light on the first device; and
wherein receiving the third encoded message comprising the second configuration of the at least one light on the first device further comprises flashing, on the first device, a second corresponding sequence of the at least one light on the first device.

7. The method of claim 6, wherein the second corresponding sequence of the at least one light on the first device further indicates that the third encoded message is from the second device.

8. The method of claim 7, further comprising receiving, at the first device from a communication device, instructions that are configured to update the second corresponding sequence of the at least one light on the first device.

9. The method of claim 1, further comprising, prior to receiving the first encoded message, pairing the first device to the second device.

10. The method of claim 1, further comprising:
sensing, at the first device, a third sequence of the at least button pressed on the first device indicating a fifth encoded message; and
sending, at the first device to the second device and a third device, the fifth encoded message.

11. A first device configured to communicate encoded message among a plurality of devices, comprising:
at least one button and at least one light disposed on the first device;
a sensor configured to sense the at least one button being pressed;
a memory that stores a module; and
a processor, coupled to the sensor, configured to run the module stored in the memory that is configured to cause the processor to:
receive, from a second device, a first encoded message comprising a first configuration of the at least one light on the first device indicating a request to communicate,
sense, a first sequence of the at least one button pressed on the first device indicating an acceptance of the request,
send, to the second device, a second encoded message corresponding to the first sequence of the at least one button pressed on the first device indicating the acceptance of the request,
receive, from the second device, a third encoded message corresponding to a second configuration of the at least one light on the first device,
sense a second sequence of the at least one button pressed on the first device indicating a reply to the third encoded message, and
send, to the second device, a fourth encoded message corresponding to the second sequence of the at least one button pressed on the first device indicating the reply to the third encoded message.

12. The first device of claim 11, wherein at least one of the first configuration or the second configuration of the at least one light on the first device comprises a plurality of colors.

13. The first device of claim 11, wherein at least one of the first encoded message or the third encoded message further comprises a third sequence of one or more vibrations of the first device;

14. The first device of claim 11, wherein the module is further configured to cause the processor to:
sense a nearby third device; and
send, to the nearby third device, a fifth encoded message corresponding to a third configuration of at least one light on the nearby third device indicating a second request to communicate.

15. The first device of claim 11, wherein the module is further configured to cause the processor to receive instructions from a communication device that are configured to update at least one of the first configuration or the second configuration of the at least one light on the first device.

16. The first device of claim 11, wherein the module is further configured to cause the processor to:
in response to receiving the first encoded message comprising the first configuration of the at least one light, flash a first corresponding sequence of the at least one light on the first device; and
in response to receiving the third encoded message comprising the second configuration of the at least one light, flash a second corresponding sequence of the at least one light on the first device.

17. The first device of claim 16, wherein the second corresponding sequence of the at least one light on the first device further indicates that the third encoded message is from the second device.

18. The first device of claim 17, wherein the module is further configured to cause the processor to receive, from a communication device, instructions that are configured to update the second corresponding sequence of the at least one light on the first device.

19. The first device of claim 11, wherein the module is further configured to cause the processor to, prior to receiving the first encoded message, pair the first device with the second device:
sense a third sequence of the at least one button pressed on the first device indicating a fifth encoded message; and
send, to the second device and a third device, the fifth encoded message.

20. A non-transitory computer readable medium having executable instructions operable to cause a first device to:
receive, from a second device, a first encoded message comprising a first configuration of at least one light on the first device indicating a request to communicate;
sense, a first sequence of at least one button pressed on the first device indicating an acceptance of the request;
send, to the second device, a second encoded message corresponding to the first sequence of the at least one button pressed on the first device indicating the acceptance of the request;
receive, from the second device, a third encoded message corresponding to a second configuration of the at least one light on the first device;
sense a second sequence of the at least one button pressed on the first device indicating a reply to the third encoded message; and
send, to the second device, a fourth encoded message corresponding to the second sequence of the at least one button pressed on the first device indicating the reply to the third encoded message.
